(19) United States
(12) Patent Application Publication
(10) Pub. No.: US 2006/0193113 A1
(43) Pub. Date: Aug. 31, 2006

(54) Controlling a surface temperature of a portable computer for user comfort in response to motion detection

(75) Inventors: Mark Evan Cohen, Cary, NC (US); Daryl Carvis Cromer, Apex, NC (US); Howard Jeffrey Locker, Cary, NC (US); Tin-Lup Wong, Chapel Hill, NC (US)

Correspondence Address: LENOVO (US) IP Law, Mail Stop ZHHA/B675/PO Box 12195, 3039 Cornwallis Road, RTP, NC, 27709-2195, US

(73) Assignee: International Business Machines Corporation, Armonk, NY (US)

(21) Appl. No.: 11/067,972

(22) Filed: Feb. 28, 2005

(51) Int. Cl. G06F 1/20

(52) U.S. Cl. 361/687

(57) ABSTRACT

A portable computer includes a motion detector providing input signals used for detecting movements indicating that the computer is held on the users lap or in his hands instead of on a desktop. When such movements are detected, the computer is operated in a first mode, with temperatures within the computer being controlled to maintain a surface of the housing at a temperature that is comfortable for the user. Otherwise, temperatures within the computer are allowed to rise to provide for faster processing or less fan noise.

### BACKGROUND OF THE INVENTION

1. Field of the Invention

This invention relates to portable computer systems, and, more particularly, to portable computer systems in which a method is performed to adjust the operation of a heat management system in response to a determination that the portable computer system is being operated on the user's lap.

2. Summary of the Background Art

Portable computer systems, including laptop computer and handheld computers can be operated at high levels of performance despite their small size, using high-density integrated circuit packages, including microprocessors. The heat generated within such components is transmitted throughout the computer, being carried outward to an extent by fan-driven airflow, and warming the external surfaces of the computer housing. When the portable computer system is placed on a desktop or on a similar rigid, horizontal surface, the warming of the bottom surface of the housing does not present a significant problem and can in fact be used to help dissipate heat generated by the computer.

However, when a laptop computer is operated on the user's lap, the bottom surface of the housing may become hot enough to cause user discomfort. The use of portable computer systems with wireless LANs (local area networks) has increased the likelihood of such discomfort, since a mode of operation having a high level of performance may be used when the computer is connected to a LAN. Before the widespread use of wireless LANs, computers connected to a LAN by means of a cable were typically located on a desktop surface where the cable connection was available, with applications running in lower power modes being executed while the computers were operated on the users' laps. Thus, what is needed is a method to prevent user discomfort by reducing the maximum temperature of the lower surface of the case of a portable computer system in response to a determination that the computer is being operated on the user's lap.

Similarly, a handheld computer may be used on a table top, with its surfaces being allowed to reach a higher temperature, or being manually held, with user comfort depending on keeping its housing surfaces from becoming too hot.

U.S, Pat. App. Pub. No. 2003/0058615 A1 describes a heat sink providing a flat surface on which a portable computer can be placed and a finned surface for heat dissipation. An attached cushioning material protects a user from the finned surface, while micro-fans, powered by the USB (Universal Serial Bus) of the computer pull air past the finned surface. Power management features of the computer reduce the power used by the fans. What is needed is a method for reducing the discomfort experienced by a person using a portable computer system without requiring the use of an additional device, separate from the computer.

The patent literature also includes a number of descriptions of methods for reducing the temperature of external surfaces of a device, such as computer system, with the methods being applied regardless of whether the device is operating on the lap of a user. For example, U.S. Pat. No. 5,978,215 describes an arrangement and method for increasing the cooling capacity of a portable personal computer having a keyboard with a rear edge hingedly connected with the bottom of an openable display panel, with at least portions of the computer electronics being housed in component structures mounted on top of the keyboard to be slid or swiveled outward, providing an increased surface area for heat dissipation. U.S. Pat. No. 6,775,135 describes heat isolation apparatus preventing an equipment surface from being heated to a high temperature from a heat source, such as an integrated circuit within a notebook computer. The heat isolation apparatus, which is connected to a fan, includes an inlet, drawing in fresh air and an isolation wall, forming a hollow structure delivering the fresh air to an outlet. U.S, Pat. App. Pub. No. 2003/0128509 A1 describes a method by which the BIOS code executing within a computer system controls the operating speed of a cooling fan according to information describing the components of the computer system, such as the microprocessor, memory configuration, and peripheral cards. The BIOS also identifies the packaging, including the housing power supply, storage device, etc. U.S, Pat. App. Pub. No. 2004/0130869 A1 describes the removal of heat from a small hand-held portable computer by dissipating the heat from surfaces that are not typically held during hand-held operation, in the form of fins located at the rear underside casing of the computer. U.S. Pat. No. 6,525,934 describes the use, within a computer, of a thermal controller including a heat pipe for moving heat generated by a microprocessor to the vicinity of the top and bottom faces of the computer, together with two heat radiating means for releasing heat in the vicinity of the top and bottom faces, and a volume switch for adjusting a quantity of heat from a heat spreader by a Peltier device.

Several patents describe the use of thermal sensors to control the operation of a thermal management system without determining whether the device is being operated on a user's lap. For example, U.S. Pat. No. 6,082,623 describes a computing system in which a CPU is switched to a proper operating mode in response to measuring a current working temperature and additionally in response to measuring a current level of airflow passing through a ventilation input and outlet. U.S, Pat. App. Pub. No. 2002/0152406 A1 describes a thermal management system monitoring a temperature of a microprocessor to dynamically throttle the operation of the microprocessor, together with the operation of at least one cooling fan. according to a thermal management program. U.S, Pat. App. Pub. No. 2002/0152406 describes a computer including at least one CPU (central processing unit), at least one fan disposed for providing cooling for at least one CPU, and a thermal manager. The thermal manager monitors a temperature of a control CPU to dynamically control a throttling of the CPU and at least one fan according to a thermal management algorithm. U.S. Pat. No. 6,225,662 describes the use of a thermal sensor connected to control logic that is capable of sensing a temperature external to the case of an electronic device, such as a computer system. The control logic is coupled to control the operation of at least one heat producing component to regulate the level at which heat is produced.

Disadvantages of the application of thermal management methods to portable computer systems without determining whether the computer is being operated on the lap of the user arise from the fact that operation of the computers on a desktop is unnecessarily compromised. For example, the performance of the computer on a desktop may be compromised by forcing the microprocessor to operate at a lower speed than necessary. Fan noise and power consumption may be increased by causing a cooling fan to operate at a faster speed than necessary. The bottom surface of a portable computer system housing forms an effective and convenient surface for heat dissipation when the computer is operating on a table surface. The devices described in U.S. Pat. Nos. 5,976,215 and 6,775,135 increase the overall size of the computer. Thus, what is needed is a thermal management system operating according to a determination of whether the computer is being operated on the user's lap.

U.S. Pat. No. 6,760,649 describes a method and system for adjusting a temperature of a bottom surface of a portable computer system based on where the computer is placed during its operation. If the computer is placed on a lap of a user, or alternatively on any surface that has direct contact with the bottom surface of the computer housing, pressure sensors on this bottom surface are activated to produce a signal initiating supplemental cooling measures to reduce the temperature of this bottom surface. Such cooling measures include decreasing an operating speed of logic circuits or increasing the output of a cooling fan. What is needed is a method for determining whether a portable computer system is being operated on the user's lap without requiring the installation and monitoring of pressure sensors on the bottom surface of the computer housing.

### SUMMARY OF THE INVENTION

In accordance with a first version of the invention, a method, including detecting movement of a portable computer, is provided for controlling a surface temperature of the housing of the portable computer. When movement of the portable computer is detected, the portable computer is operated in a first mode. When movement of the portable computer is then not detected during a first predetermined time period, the portable computer is operated in a second mode, allowing operation at higher temperatures than the first mode. Movement of the portable computer may be detected by receiving an electrical signal from an accelerometer mounted within the portable computer or by receiving an electrical signal from an optical sensor directed to sense relative movement between the personal computer and a surface disposed below the portable computer.

In this way, the portable computer is allowed to operate at higher temperatures when it is stationary on the top of a desk, than when it he held on the users lap or in his hands, with movement of the portable computer occurring due to fidgeting or other natural user movements. Operation at the cooler temperatures provides for user comfort, while operation at the higher temperatures allows faster processing and lower fan speeds when the portable computer is operated on a table surface.

The method of the invention may include measuring a temperature within the housing, comparing the measured temperature with a first reference temperature and modifying operating conditions within the portable computer to reduce the temperature within the housing in response to determining that the measured temperature exceeds the first reference temperature. When the portable computer is operated in the first mode, the first reference temperature is set at a first level. When the portable computer is operated in the second mode, the first reference temperature is set at a second level, higher than the first level. The temperature within the housing may be reduced by increasing the speed of a cooling fan or by decreasing the processing speed of a microprocessor within the portable computer. After is is determined that the measured temperature is less than the first reference temperature, the measured temperature may be compared to a second reference temperature, lower than the first reference temperature. If it is determined that the measured temperature is below the second reference temperature, the portable computer is allowed to operate at a higher temperature by decreasing the fan speed or by increasing the processing speed of the microprocessor.

A user interface may additionally be provided through the display of a graphical control providing a choice between operation at a cooler temperature or at a higher speed. Data indicating a user selection made with the graphical control is received and stored to set a condition of the first mode of operation. For example, the first value of the reference temperature may be set in this way.

### BRIEF DESCRIPTION OF THE FIGURES

FIG. 1 is a partly sectional right side elevation of a portable computer system built in accordance with the invention;

FIG. 2 is a block diagram showing elements within the portable computer system of FIG. 1;

FIG. 3 is a flow chart showing processes occurring during execution of a first version of a motion detection routine within the portable computer system of FIG. 1;

FIG. 4 is a flow chart showing processes occurring during execution of a first version of a thermal management routine within the portable computer system of FIG. 1;

FIG. 5 is a flow chart showing processes occurring during execution of a second version of a motion detection routine within the portable computer system of FIG. 1;

FIG. 6 is a flow chart showing processes occurring during execution of a second version of a thermal management routine within the portable computer system of FIG. 1, being divided between an upper portion, indicated as FIG. 6A, and a lower portion, indicated as FIG. 6B;

FIG. 7 shows a slider control displayed on a display panel of the portable computer system of FIG. 1 to provide a user interface;

FIG. 8 is a flow chart showing processes occurring during the display of the slider control of FIG. 7; and

FIG. 9 is a fragmentary cross-sectional elevation of a portable computer built in accordance with the invention to include an alternative motion detector.

### DETAILED DESCRIPTION OF THE INVENTION

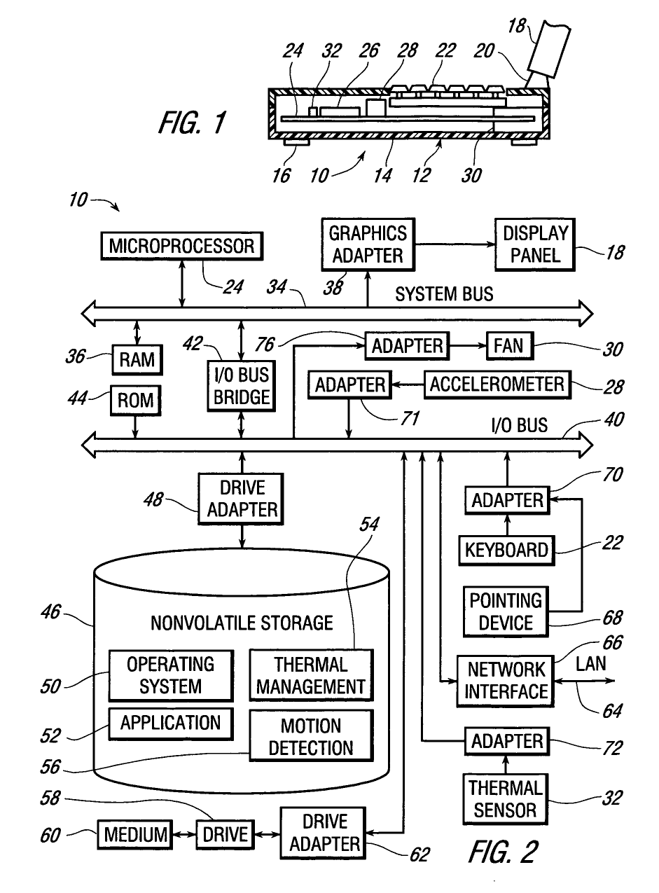

FIG. 1 is a partly sectional right side elevation of a portable computer system 10 built in accordance with the invention. The portable computer system 10 includes a housing 12 having a bottom surface 14, which rests on the lap of the user when he uses the system on his lap. Otherwise, the portable computer system 10 may be placed on a desk or table to rest on four pads 16 located near the corners of the housing 12. The portable computer system 10 additionally includes a display panel 18, pivotally attached to the housing 12 by means of a hinge 20, and a keyboard 22. Internal components of the portable computer system 10 include a system board 24, on which a microprocessor 26, an motion sensor 28, which is, for example, an accelerometer, and other components (not shown) are mounted, and a cooling fan 30, which is preferably located to draw air inward and to blow air outward at locations, such as along the back, sides, and the bottom surface 14 near a corner, where a flow of air will not be blocked by the legs of a user resting the computer 10 on his lap. The portable computer system 10 may also include a thermal sensor 32, located near the microprocessor 26.

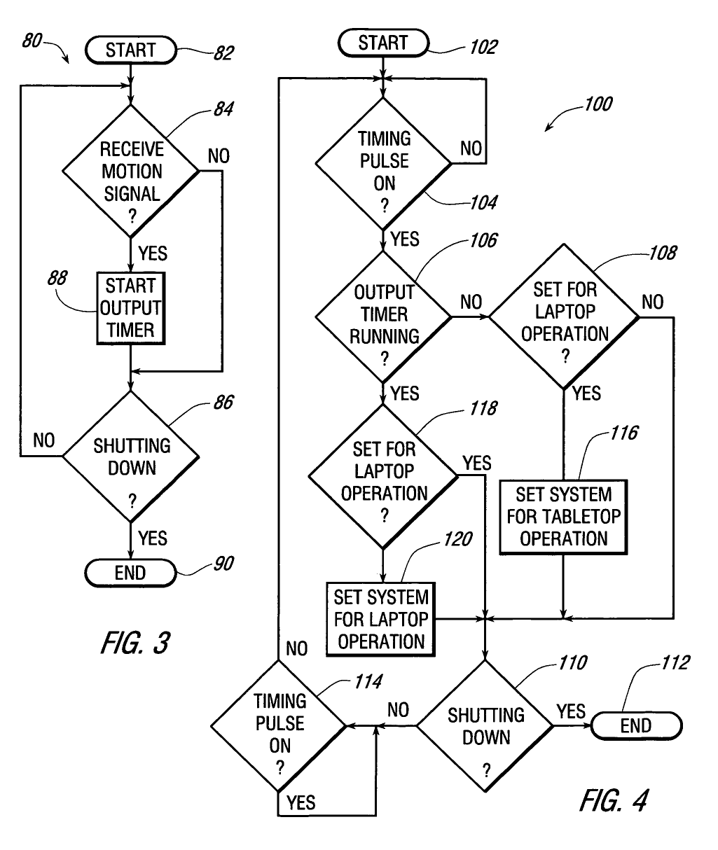

FIG. 2 is a block diagram showing elements within the portable computer system 10, which includes the microprocessor 26 connected to a system bus 34 for the transfer of data, along with a RAM (random access memory) 36, and a graphics adapter 38, which provides signals to drive the display panel 18. The system bus 34 is also connected to an I/O (input/output) bus 40 through an I/O bus bridge 42, which relays information between the buses 34, 40, making data transformations as required. A ROM (read-only memory) 44, connected to the I/O bus 40, stores instructions for initializing the operation of the portable computer system 10 when power is turned on. Nonvolatile storage 46, which is provided, for example, through the use of a hard disk drive connected to the I/O a drive adapter 48, stores instructions and data for an operating system 50 and one or more application programs 52. In accordance with the invention, nonvolatile storage 46 additionally stores data and instructions for a thermal management routine 54 and for a motion detection routine 56. Data and instructions for programs executing within the microprocessor 26 are read from nonvolatile storage 46 to be loaded into RAM 36. The portable computer system 10 additionally includes a drive 58 for reading information from a removable medium 60, such as an optical disk, with the drive 58 being connected to the I/O bus 40 through a drive adapter 62. A LAN (local area network) through a network interface circuit 66.

Program instructions to be executed within the portable computer system 10 may be loaded from the removable medium 60, which forms a computer readable medium, through the drive 58, to be stored in nonvolatile storage 46 or to be stored for execution within the RAM 36, with nonvolatile storage 46 and RAM 36 additionally forming examples of computer readable media. Alternately, such instruction s can be received in the form of a computer data signal embodied on a carrier wave from the LAN 64 through the network interface circuit 66. User inputs to the portable computer system 10 are provided through the keyboard 22 and through a pointing device 68, such as a mouse or touch pad, both of which are attached to the I/O bus 40 through an adapter 70.

According to a preferred version of the invention, the portable computer system 10 further includes the accelerometer 28, connected to the I/O bus 40 through an adapter circuit 71. For example, the accelerometer 28 may be a device including a centrally suspended weight that is moved into contact with electrical contacts around the weight by acceleration of the portable computer system 10 in various directions. The adapter 71 converts signals from the accelerometer 28 into signals that can be driven along the I/O bus 40 to indication the measurement of acceleration by the accelerometer 28. Preferably, the thermal sensor 32 is additionally connected to the I/O bus 40 through an adapter 72. For example, the thermal sensor 32 is a thermocouple measuring temperature within the portable computer system 10, being placed near the microprocessor 26, which forms both a heat source and a component that can be adversely affected by high temperatures, or near the bottom surface 14 of the housing 12, the temperature of which is controlled to provide for user comfort during operation of the portable computer system 10 on the user's lap. The cooling fan 30 is preferably driven at various speeds, for example, with a fan driving current being applied to the fan 28 through an adapter circuit 76 at a level determined according to signals received from the I/O bus 40.

FIG. 3 is a flow chart showing processes occurring during execution of a first version 80 of the motion detection routine 56. Preferably, this motion detection routine 80 is started in step 82 during an initialization process occurring after power-on, being part of BIOS (Basic Input/Output System) routine executing from instructions stored in the ROM 44. Alternatively, the motion detection routine may be called by the operating system 50. After starting in step 82, the routine 80 repeatedly proceeds through step 84, in which a determination is made of whether a motion detection signal has been received from the accelerometer 28, and through step 86, in which a further determination is made of whether the portable computer system 10 is shutting down. When it is determined in step 84 that a motion detection signal has been received, operation of an output timer is started in step 88. This output timer, which may be implemented through hardware or software, then runs for a predetermined time period, during which the thermal management routine 54 provides for operation in a first mode controlling the temperature of the lower surface 14 of the case 12 to provide for user comfort during laptop or hand held operation. The duration of the predetermined time period is preferably chosen so that the timer runs continuously during typical operation of the portable computer system 10 on the user's lap or in his hands while allowing the computer 10 to return to less strict control of the case temperature through operation in a second mode during use on a desktop following placement thereon or movement along the desktop surface. Following a determination in step 86 that the portable computer system 10 is shutting down, the motion detection routine 56 ends in step 90.

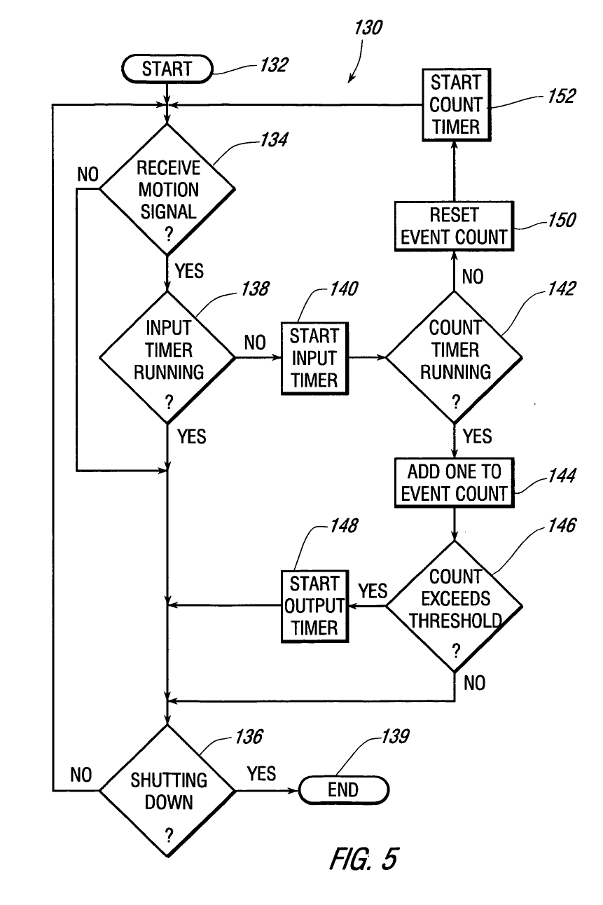

FIG. 4 is a flow chart of processes occurring during execution of a first version 100 of the thermal management program 54 within the portable computer system 10. Preferably, this thermal management program 100 is started in step 102 during an initialization process occurring after power-on, being part of BIOS instructions stored in the ROM 44 or being called by the operating system 50. The thermal management program 100 determines on a periodic basis, established by a sequence of timing pulses, whether the output timer set in step 88 of FIG. 3, is running and, accordingly, arranges for the operation of the portable computer system 10 either in a mode suitable for laptop operation or in a mode suitable for desktop operation.

After starting in step 102, the thermal management program 100 proceeds to step 104, in which a determination is made of whether the timing pulse is on, indicating that the time has arrived to perform the various processes of the program 100. If the timing pulse is not on, the program 100 returns to step 104, effectively waiting until it is determined that the timing pulse is on before proceeding to step 106, in which a further determination is made of whether the output timer, having been set in step 88, is still running. If it is, the portable computer system 10 should be set for laptop operation, but first, it is determined in step 108 whether this has already occurred. If it is determined in step 108 that the computer 10 is operating in the first mode, being set for laptop or hand held operation, the thermal management program 100 proceeds to step 110, in which a further determination is made of whether the computer 10 is shutting down. If it is, the thermal management program 112 is ended in step 112; otherwise, another determination of whether the timing pulse is on is made in step 114. If the timing pulse is still on, the thermal management program 100 returns to step 114, waiting for the timing pulse to be turned off before returning to step 104. In this way, it is assured that the various process steps of the thermal management program 100 will be performed only once for each of the timing pulses. If it is determined in step 108 that the portable computer system 10 is not set for laptop operation, the system is then set for laptop operation in step 116, before proceeding to step 110. On the other hand, when it is determined in step 106 that the output timer is not running, a further determination is made in step 118 of whether the portable computer system 10 is operating in the first mode, being set for laptop or hand held operation. If it is, the program 100 proceeds to step 110; otherwise the portable computer system 10 is set for laptop or hand held operation in step 120 before proceeding to step 110.

For operation as described above in reference to FIG. 4, the computer system 10 must be capable of operation in a first mode, being set for laptop or hand held operation, and in a second mode, being set for tabletop operation. The difference between these modes of operation may be simply the speed of operation of the cooling fan 30. Alternatively or additionally, the speed of operation of the microprocessor 26 may be limited when the computer 10 is set for laptop operation. Alternatively, feedback means responsive to a temperature measured with the thermal sensor 32 may be employed in a manner that is additionally affected by whether the computer 10 has been set for laptop or hand held operation, or for tabletop operation.

FIG. 5 is a flow chart showing processes occurring during execution of a second version 130 of the motion detection routine 56. This routine 130 is configured to provide a first time period during which only a single motion detection signal is used to effect operation of the computer system 10. After the first occurrence of this motion detection signal, additional occurrences of this signal are ignored, so that the effects of bouncing within the accelerometer following a movement of the portable computer system 10 are ignored, and so that a movement that occurs over a relatively short period of time, such as sliding the computer 10 along a table top is considered to be a detection of only one motion. Additionally, the output timer is set to indicate that laptop motion has been detected only in response to the occurrence of a predetermined number of movements of the portable computer system 10 during a second time period. Both the predetermined number of movements and the second time period are chosen so that the motion detection routine 130 responds to typical movements, such as fidgeting, of a user during laptop or hand held operation of the computer 10 but not to typical movements, such as sliding the computer 10 from one position to another, during its operation on a desktop. The duration of running the output timer is also chosen so that continuous operation of the output timer is provided in response to such typical movements of a user during laptop operation without unreasonably extending the time at which the computer 10 is conditioned for desktop operation following its placement on a desk top.

Preferably, this motion detection routine 130 is started in step 132 during an initialization process occurring after power-on of the computer 10, being part of a BIOS routine stored in the ROM 44, being called by such a BIOS routine, or being called by the operating system 50. After starting in step 132, the routine 130 repeatedly proceeds through step 134, in which a determination is made of whether a motion detection signal has been received from the accelerometer 28, and through step 136, in which a further determination is made of whether the portable computer system 10 is shutting down. When it is determined in step 134 that the motion detection signal has been received, a further determination is made in step 138 of whether the input timer is running. If it is running, the motion detection signal is understood to be the result of contact bouncing or, for example, the result of stopping a movement that has been begun when a previous motion detection signal was received, so the motion detection signal is not counted as the motion detection routine 130 proceeds to step 136. When it is determined in step 136 that the computer 10 is shutting down, the motion detection routine 130 ends in step 139; otherwise the routine 130 returns to step 134.

If it is determined in step 138 that the input timer is not running, this timer is started in step 140, with the motion detection routine 130 then proceeding to step 142, so that the motion detection signal will be counted. If it is determined in step 142 that the count timer is running, indicating operation of the process of counting motion signal events to determine whether the predetermined number of such events occurs during the time provided by running the count timer, a value of one is added to the count of motion signal events in step 144. Then, in step 146, a determination is made of whether this count exceeds a threshold level. If it does, indicating that the predetermined number of motion signal detection events has occurred, the output timer started in step 148 before the routine 130 proceeds to step 136. If it is determined in step 144 that the threshold level has not been exceeded, the routine 130 proceeds to step 136, with the motion detection event count 144 having been increased by a value of one in step 144. If it is determined in step 142 that the count timer is not running, the motion detection event count is reset in step 150 to indicate that only one such event has occurred during the present period for counting such events, with the count timer then being started in step 152. In this way, the output timer is started to indicate the detection of movement only when an output signal from the accelerometer has occurred during a each of predetermined number of time periods, defined by the duration of the input timer.

The input timer, count timer, and output timer may be implemented in hardware in the form of dedicated timing circuits or in software, with pulses being counted as numbers are stored within registers. FIG. 5 reflects an understanding that each of these counters resets itself after running for a predetermined time.

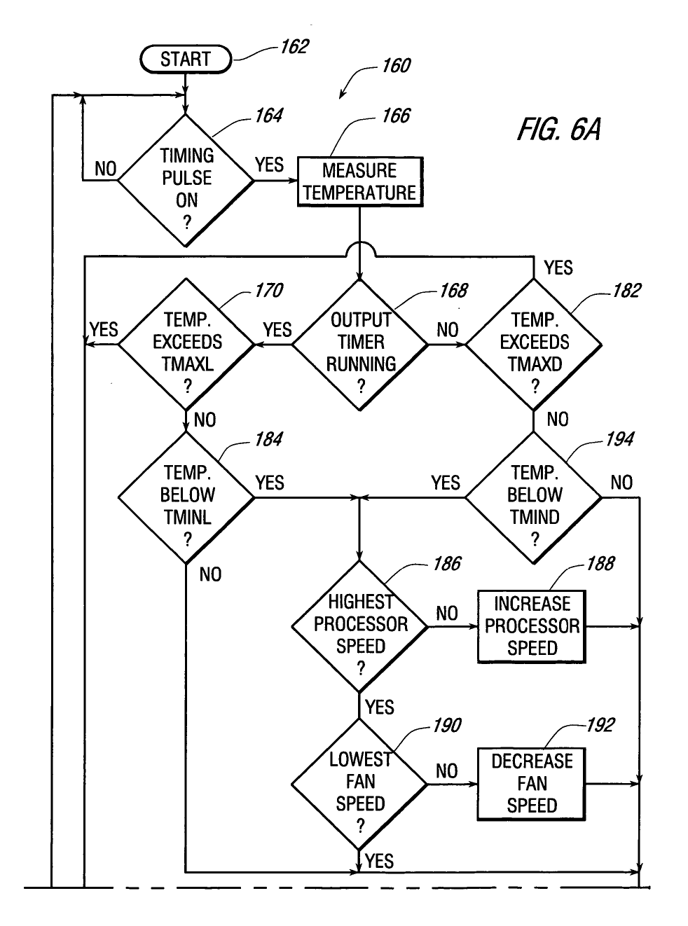

FIG. 6 is a flow chart of processes occurring during execution of a second version 160 of the thermal management program 54 within the portable computer system 10. FIG. 6 is divided into an upper portion, indicated as FIG. 6A, and a lower portion, indicated as FIG. 6B. Preferably, this thermal management program 160 is started in step 162 during an initialization process occurring after power is turned on within the portable computer system 10, with various processes occurring on a periodic basis established by a train of timing pulses. Thus, after starting in step 162, this thermal management program 160 proceeds to wait for one of these timing pulses in step 164. When the timing pulse occurs, the temperature measured by the thermal sensor 32 is measured in step 166. Then, in step 168, a determination is made of whether the output timer is running, having been started by the motion detection routine 56. If the output timer is running, indicating that laptop or handheld operation has been detected, a further determination is made in step 170 of whether the temperature measured in step 166 exceeds TMAXL, a predetermined maximum desirable temperature for laptop operation. If the measured temperature exceeds TMAXL, the thermal management program 160 proceeds to step 172, in which a further determination is made of whether the fan 30 is already turning at its maximum speed. If it is not, this fan speed is increased in step 174. If the fan is determined in step 172 to be already turning at its fastest speed, a further determination is made in step 176 of whether the microprocessor 24 is already operating at its lowest speed. If it is then additionally determined that the application program 52 executing within the portable computer system can be operated at a lower processor speed, the processor speed is lowered in step 180. If it is determined in step 168 that the output timer is not running, indicating that laptop operation has not been detected, a further determination is made in step 182 of whether the temperature measured in step 166 exceeds TMAXD, a predetermined maximum desirable temperature for desktop operation. If it is determined to exceed TMAXD, the thermal management system proceeds to step 172 to enter the process described above.

Thus, within the thermal management program 160, a prior determination of the motion detection routine 56 of whether laptop or handheld operation is occurring is used to determine how a measured temperature is evaluated by comparison with a first reference temperature, which is TMAXL if the portable computer 10 is operating in the first mode, with laptop or handheld operation having been detected, or TMAXD if the computer 10 is operating in the second mode for tabletop operation. If the measured temperature is then determined to be too high, an attempt is made to lower the temperature of operation, with a preference being given to increasing fan speed, if possible. If it is not possible to increase fan speed, the processor speed is decreased, with a resulting decrease in performance of the portable computer system 10, but only after it has been determined that the application running within the compute 10 will continue running at the lower processor speed.

On the other hand, it may be determined that the computer system 10 is operating at an unnecessarily low temperature, at a reduced level of performance or with the cooling fan running too fast, so that additional noise is generated with additional electrical power being used. Therefore, after it is determined in step 170 that the temperature measured in step 166 dies not exceed TMAXL, a further determination is made in step 184 of whether this temperature is below TMINL, a predetermined minimum desirable temperature to which the portable computer system 10 is to be cooled during laptop operation. If the temperature is then determined to be below TMINL, it is then determined in step 186 whether the microprocessor 24 is running at its fastest processor speed. If it is not, the processor speed is increased in step 188. If it is determined in step 186 that the microprocessor 24 is running at its fastest processor speed, a further determination is made in step 190 of whether the cooling fan 30 is running at its lowest speed. In this regard, the lowest speed for the cooling fan may be achieved by turning the fan off. If the fan is determined in step 190 not to be running at its lowest speed, the fan speed is decreased in step 192. Similarly, if it is determined in step 182 that the temperature measured in step 166 does not exceed TMAXD, a further determination is made in step 194 of whether this temperature is below TMIND, a predetermined minimum desirable temperature to which the portable computer system 10 is to be cooled during desktop operation. If the temperature is then determined to be below TMIND, the thermal management program 160 proceeds to step 182 to operate as described above.

Thus, within the thermal management program 160, a prior determination of the motion detection routine 56 of whether laptop or handheld operation is occurring is used to determine how a measured temperature is evaluated by comparison with a second reference temperature, which is TMINL if the portable computer 10 is operating in the first mode, with laptop or handheld operation having been detected, or TMIND if the computer 10 is operating in the second mode for tabletop operation.

After the cooling performance of the portable computer system 10 is thus increased in steps 174 or 180, or after this cooling performance is in steps 188 or 192, or after it is otherwise determined that the cooling performance is not to be changed, the thermal management program 160 proceeds to step 196, in which it is determined whether the portable computer system 10 is shutting down. If it is, the program 160 ends in step 198. Otherwise, the program 160 proceeds to step 200 to wait, if necessary, for the timing pulse to end, so that the various processes occurring after step 164 occur only once for each timing pulse. Then, the program 160 returns to step 164 to wait for the next timing pulse.

The user may be provided with an interface providing a measure of control over the temperature allowed during laptop operation, being given a choice between a cool housing temperature and faster performance of the portable computer system 10. For example, such an interface may be used by a person sensitive to heat and wearing thin clothing to solicit a lower housing temperature or by a person insensitive to heat, wearing warmer clothing, and more sensitive to performance of the portable computer system 10 to allow a warmer housing temperature.

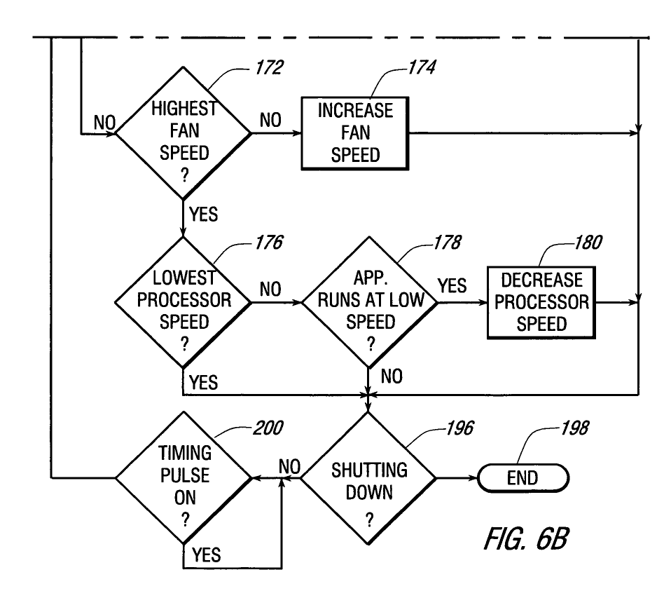

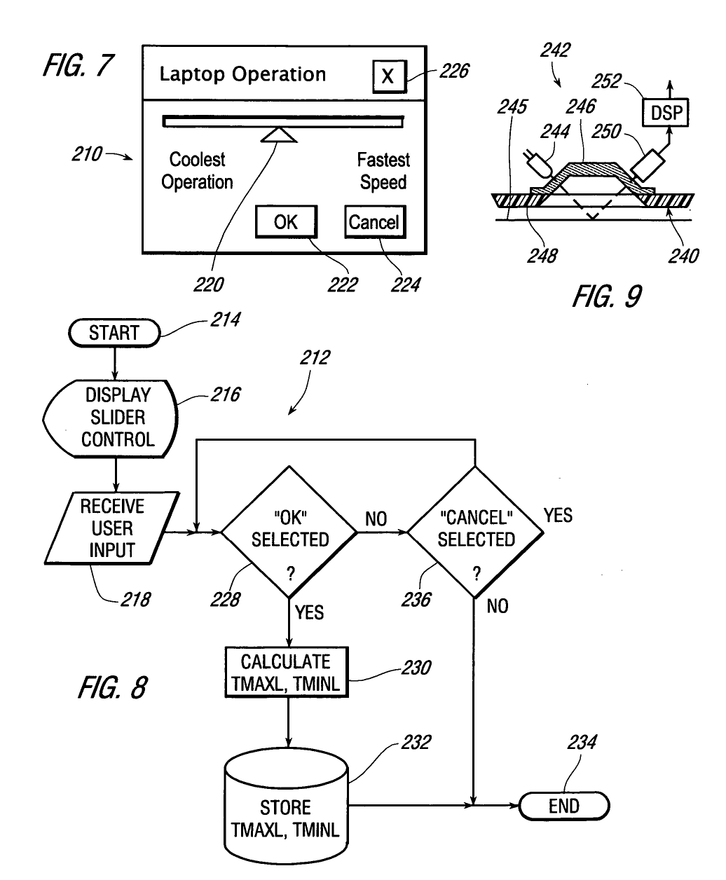

Thus, FIG. 7 shows a graphical control in the form of a slider control 210 that is displayed on the display panel 18 to provide a user interface, while FIG. 8 is a flow chart showing a user interface subroutine 212 occurring with the display of the slider control 210. The subroutine 212 starts in step 214, for example, when the user selects an associated option on a control panel screen displayed by the operating system 50. After starting in step 214, the interface subroutine 212 displays the slider control 210 in step 216, with user input then being received in step 218. The user selects the position indicator 220 of the control 210 with the pointing device 68 and drags this indicator 220 to the left to lower the operating temperature of the computer 10 during laptop operation or to the right to increase the processor speed, while increasing the allowable operating temperature. When the user is satisfied with the position of the indicator 220, he selects the “OK” command button 222. If the user does not desire to change the position of the indicator 220 in this way, he selects the “Cancel” command button 224 or produces a similar effect by canceling the display of the control 210 through the selection of the “X” button 226. If it is determined in step 228 that the “OK” command button 222 has been selected, values of TMAXL and TMINL are calculated in step 230 to correspond with the position of the indicator 220, with these values being then stored in step 232 before the subroutine 212 ends in step 234, with the display of the slider control 210 being ended. If it is determined in step 236 that the “Cancel” command button 224 has been selected, the subroutine 212 ends without changing the previously stored values of TMAXL and TMINL.

While the preceding discussion has described the use of an accelerometer to provide an electrical signal for motion detection, it is understood that another type of motion detector can alternately be used. For example, FIG. 9 is a partly-schematic and fragmentary cross-sectional elevation of a portable computer 240 built in accordance with the invention to include an alternative motion detector 242, including a lamp 244, such as an LED (light emitting diode), illuminating an external surface 245 disposed below the portable computer 240 through a transparent dome 246 extending upward from the lower surface 248 of the portable computer 240. An optical sensor 250 is disposed to view a reflected image of the external surface 245 and to thereby detect motion of the portable computer 240 relative to the surface 245. For example, the optical sensor 250 is a CMOS device of a type presently used in optical pointing devices, otherwise known as optical mice. The output signal of the optical sensor 250 is provided as an input to a DSP (digital signal processor) 252 that in turn provides an electrical signal indicating that relative movement has been detected. Preferably, and indication that a surface cannot be detected is given an effect similar to that of detected motion, so that only a stationary surface close enough to provide a stationary pattern is considered to be an indication of desktop usage.

While the invention has been described in its preferred form or embodiments with some degree of particularity, it is understood that this description has been given only by way of example, and that various changes can be made without departing from the spirit and scope of the invention, as defined in the appended claims.

What is claimed is:

1. A method for controlling a temperature of a housing surface of a portable computer, wherein the method comprises:
detecting movement of the portable computer;
in response to detecting movement of the portable computer, operating the portable computer in a first mode; and
in response to a failure to detect movement of the portable computer during a first predetermined time period, operating the portable computer in a second mode, wherein the second mode allows operation of the portable computer at a higher internal temperature than the first mode.

2. The method of claim 1, wherein movement of the portable computer is detected by receiving an electrical signal from an accelerometer mounted within the portable computer.

3. The method of claim 1, wherein movement of the portable computer is detected by receiving an electrical signal from an optical sensor directed to sense movement between the portable computer and an illuminated surface disposed below the portable computer.

4. The method of claim 1, wherein movement is detected by detection, within a second predetermined time period, of a predetermined number of indications that an motion sensor has produced an electrical signal.

5. The method of claim 4, wherein each of the indications is produced in response to detecting a predetermined number of time periods in which the motion sensor has produced an electrical signal.

6. The method of claim 1, wherein a cooling fan within the portable computer is operated at a higher speed in the second mode than in the first mode.

7. The method of claim 1, wherein a microprocessor within the portable computer is operated at a lower processing speed in the second mode than in the first mode.

8. The method of claim 1, additionally comprising:
measuring a temperature within the housing;
comparing the temperature within the housing with a first reference temperature; and
modifying operating conditions within the portable computer to reduce the temperature within the housing in response to a determination that the temperature measured within the housing exceeds the first reference temperature.

9. The method of claim 8, wherein the first reference value is at a first level during operation of the portable computer in the first mode and at a second level, higher than the first level, during operation of the portable computer in the second mode.

10. The method of claim 8, additionally comprising modifying operations within the portable computer to allow the temperature within the housing to reach a higher level in response to a determination that the temperature measured within the housing is lower than a second reference temperature.

11. The method of claim 10, wherein the second reference value is at a first level during operation of the portable computer in the first mode and at a second level, higher than the first level, during operation of the portable computer in the second mode.

12. A portable computer comprising:
a housing
a motion sensor producing an output signal in response to movement of the portable computer; and
a microprocessor programmed to detect movement of the portable computer in response to receiving the output signal of the motion sensor, to cause operation of the portable computer in a first mode in response to detecting movement of the portable computer, and to cause operation of the portable computer in a second mode in response to failing to detect the output signal of the motion sensor during a first predetermined time period, wherein the second mode allows operation of the portable computer at a higher temperature within the housing than the first mode.

13. The portable computer of claim 12, wherein the microprocessor detects movement of the portable computer by a method including:
receiving an output signal from the motion sensor;
determining whether an input timer is running to indicate that an output signal from the motion sensor has been recently received;
in response to determining that the input timer is not running, starting the input timer and increasing a stored count of signal detection events; and
determining that the stored count of signal detection events exceeds a predetermined threshold level.

14. The portable computer of claim 12, additionally comprising a thermal sensor, wherein the microprocessor is programmed to perform a method comprising:
periodically comparing a temperature measured by the thermal sensor with a first level of a first reference temperature during operation of the portable computer in the first mode and with a second level of the first reference temperature, higher than the first level of the first reference temperature, during operation in the second mode, and
in response to determining that the temperature measured by the thermal sensor is higher than the first reference temperature, modifying operating conditions within the portable computer to reduce a temperature within the housing.

15. The portable computer of claim 14, additionally comprising a cooling fan, wherein the microprocessor is programmed to modify operating conditions within the portable computer to reduce a temperature within the housing by performing a method including:
determining that the cooling fan is not operating at its highest speed; and
increasing the speed of the cooling fan.

16. The portable computer of claim 14, wherein the microprocessor is operable at two or more different processing speeds, and wherein the microprocessor is programmed to modify operating conditions within the portable computer to reduce a temperature within the housing by performing a method including:
determining that the microprocessor is not operating at its lowest processing speed; and
decreasing the processing speed of the microprocessor.

17. The portable computer of claim 16, wherein the microprocessor is programmed to modify operating conditions within the portable computer to reduce a temperature within the housing by performing a method additionally including determining that an application running in the portable computer can operate at a lower process speed before decreasing the processing speed of the microprocessor.

18. The portable computer of claim 14, wherein
the microprocessor is operable at two or more different processing speeds, and
the microprocessor is programmed to modify operating conditions within the portable computer to reduce a temperature within the housing by performing a method additionally including determining, in response to a determination that the cooling fan is operating at its highest speed, determining that the microprocessor is not operating at its lowest processing speed and decreasing the processing speed of the microprocessor.

19. The portable computer of claim 14, wherein the method additionally comprises:
comparing a temperature measured by the thermal sensor with a first level of a second reference temperature during operation of the portable computer in the first mode and with a second level of the second reference temperature, higher than the first level of the first reference temperature, during operation in the second mode, and
in response to determining that the temperature measured by the thermal sensor is lower than the second reference temperature, modifying operating conditions within the portable computer to allow a temperature within the housing to reach a higher level.

20. The portable computer of claim 19, additionally comprising a cooling fan, wherein the microprocessor is programmed to allow a temperature within the housing to reach a higher level by performing a method including:
determining that the cooling fan is not operating at its lowest speed; and
decreasing the speed of the cooling fan.

21. The portable computer of claim 19, wherein the microprocessor is operable at two or more different processing speeds, and wherein the microprocessor is programmed to modify operating conditions within the portable computer by performing to allow a temperature within the housing to reach a higher level a method including:
determining that the microprocessor is not operating at its highest processing speed; and
increasing the processing speed of the microprocessor.

22. The portable computer of claim 12, wherein the motion sensor includes an accelerometer mounted within the portable computer.

23. The portable computer of claim 12, wherein the motion sensor includes:
a lamp for illuminating a surface disposed below the portable computer; and
an optical sensor disposed to detect relative movement between the portable computer and the surface disposed below the portable computer.

24. The portable computer of claim 12, wherein the microprocessor is additionally programmed to perform a method comprising:
displaying a graphical control providing a choice between operation at a cooler temperature or at a faster speed;
receiving data indicating a user selection using the graphical control; and
storing data to set a condition of the first mode in response to the data received indicating a user selection.

25. The portable computer of claim 24, additionally comprising a thermal sensor, wherein the data stored to set a condition of the first mode includes a reference temperature to which a temperature measured by the thermal sensor is compared.

26. A computer readable medium having instructions executable within a portable computer for performing a method comprising:
detecting movement of the portable computer in response to receiving an output signal of a motion sensor;
causing operation of the portable computer in a first mode in response to detecting movement of the portable computer; and
causing operation of the portable computer in a second mode in response to failing to detect the output signal of the motion sensor during a first predetermined time period, wherein the second mode allows operation of the portable computer at a higher temperature within the housing than the first mode.

27. The computer readable medium of claim 26, wherein the method includes, for detecting movement of the portable computer:
receiving an output signal from the motion sensor;
determining whether an input timer is running to indicate that an output signal from the motion sensor has been recently received;
in response to determining that the input timer is not running, starting the input timer and increasing a stored count of signal detection events; and
determining that the stored count of signal detection events exceeds a predetermined threshold level.

28. The computer readable medium of claim 26, wherein the method comprises:
periodically comparing a temperature measured by a thermal sensor with a first level of a first reference temperature during operation of the portable computer in the first mode and with a second level of the first reference temperature, higher than the first level of the first reference temperature, during operation in the second mode, and
in response to determining that the temperature measured by the thermal sensor is higher than the first reference temperature, modifying operating conditions within the portable computer to reduce a temperature within the housing.

29. The computer readable medium of claim 28, wherein the method additionally includes, in response to determining that the temperature measured by the thermal sensor is higher than the first reference temperature:
determining that the cooling fan is not operating at its highest speed; and
increasing the speed of the cooling fan.

30. The computer readable medium of claim 28, wherein the method additionally includes, in response to determining that the temperature measured by the thermal sensor is higher than the first reference temperature:
determining that a microprocessor within the portable computer is not operating at its lowest processing speed; and
decreasing the processing speed of the microprocessor.

31. The computer readable medium of claim 30, wherein the method additionally includes, in response to determining that the temperature measured by the thermal sensor is higher than the first reference temperature, determining that an application running in the portable computer can operate at a lower process speed before decreasing the processing speed of the microprocessor.

32. The computer readable medium of claim 28, wherein the method additionally includes, in response to determining that the temperature measured by the thermal sensor is higher than the first reference temperature, and additionally in response to a determination that the cooling fan is operating at its highest speed, determining that the microprocessor is not operating at its lowest processing speed and decreasing the processing speed of the microprocessor.

33. The computer readable medium of claim 28, wherein the method additionally comprises:
comparing a temperature measured by the thermal sensor with a first level of a second reference temperature during operation of the portable computer in the first mode and with a second level of the second reference temperature, higher than the first level of the first reference temperature, during operation in the second mode, and
in response to determining that the temperature measured by the thermal sensor is lower than the second reference temperature, modifying operating conditions within the portable computer to allow a temperature within the housing to reach a higher level.

34. The computer readable medium of claim 33, wherein the method additionally includes, in response to determining that the temperature measured by the thermal sensor is lower than the second reference temperature:
determining that a cooling fan within the portable computer is not operating at its lowest speed; and
decreasing the speed of the cooling fan.

35. The computer readable medium of claim 34, wherein the method additionally includes, in response to determining that the temperature measured by the thermal sensor is lower than the second reference temperature:
determining that the microprocessor is not operating at its highest processing speed; and
increasing the processing speed of the microprocessor.

36. The computer readable medium of claim 26, wherein the method additionally comprises:
displaying a graphical control providing a choice between operation at a cooler temperature or at a faster speed;
receiving data indicating a user selection using the graphical control; and
storing data to set a condition of the first mode in response to the data received indicating a user selection.

37. The computer readable medium of claim 36, wherein the data stored to set a condition of the first mode includes a reference temperature to which a temperature measured by the thermal sensor is compared.

38. A computer data signal embodied in a carrier wave having instructions executable within a portable computer for performing a method comprising:
detecting movement of the portable computer in response to receiving an output signal of a motion sensor;
causing operation of the portable computer in a first mode in response to detecting movement of the portable computer; and
causing operation of the portable computer in a second mode in response to failing to detect the output signal of the motion sensor during a first predetermined time period, wherein the second mode allows operation of the portable computer at a higher temperature within the housing than the first mode.

39. The computer data signal of claim 38, wherein the method includes, for detecting movement of the portable computer:
receiving an output signal from the motion sensor;
determining whether an input timer is running to indicate that an output signal from the motion sensor has been recently received;
in response to determining that the input timer is not running, starting the input timer and increasing a stored count of signal detection events; and
determining that the stored count of signal detection events exceeds a predetermined threshold level.

40. The computer data signal of claim 38, wherein the method comprises:
periodically comparing a temperature measured by a thermal sensor with a first level of a first reference temperature during operation of the portable computer in the first mode and with a second level of the first reference temperature, higher than the first level of the first reference temperature, during operation in the second mode, and
in response to determining that the temperature measured by the thermal sensor is higher than the first reference temperature, modifying operating conditions within the portable computer to reduce a temperature within the housing.

41. The computer data signal of claim 40, wherein the method additionally includes, in response to determining that the temperature measured by the thermal sensor is higher than the first reference temperature:
determining that the cooling fan is not operating at its highest speed; and
increasing the speed of the cooling fan.

42. The computer data signal of claim 40, wherein the method additionally includes, in response to determining that the temperature measured by the thermal sensor is higher than the first reference temperature:
determining that a microprocessor within the portable computer is not operating at its lowest processing speed; and
decreasing the processing speed of the microprocessor.

43. The computer data signal of claim 42, wherein the method additionally includes, in response to determining that the temperature measured by the thermal sensor is higher than the first reference temperature, determining that an application running in the portable computer can operate at a lower process speed before decreasing the processing speed of the microprocessor.

44. The computer data signal of claim 40, wherein the method additionally includes, in response to determining that the temperature measured by the thermal sensor is higher than the first reference temperature, and additionally in response to a determination that the cooling fan is operating at its highest speed, determining that the microprocessor is not operating at its lowest processing speed and decreasing the processing speed of the microprocessor.

45. The computer data signal of claim 40, wherein the method additionally comprises:
comparing a temperature measured by the thermal sensor with a first level of a second reference temperature during operation of the portable computer in the first mode and with a second level of the second reference temperature, higher than the first level of the first reference temperature, during operation in the second mode, and
in response to determining that the temperature measured by the thermal sensor is lower than the second reference temperature, modifying operating conditions within the portable computer to allow a temperature within the housing to reach a higher level.

46. The computer data signal of claim 45, wherein the method additionally includes, in response to determining that the temperature measured by the thermal sensor is lower than the second reference temperature:
determining that a cooling fan within the portable computer is not operating at its lowest speed; and
decreasing the speed of the cooling fan.

47. The computer data signal of claim 45, wherein the method additionally includes, in response to determining that the temperature measured by the thermal sensor is lower than the second reference temperature:
determining that the microprocessor is not operating at its highest processing speed; and
increasing the processing speed of the microprocessor.

48. The computer data signal of claim 38, wherein the method additionally comprises:
displaying a graphical control providing a choice between operation at a cooler temperature or at a faster speed;
receiving data indicating a user selection using the graphical control; and
storing data to set a condition of the first mode in response to the data received indicating a user selection.

49. The computer data signal of claim 48, wherein the data stored to set a condition of the first mode includes a reference temperature to which a temperature measured by the thermal sensor is compared.
